(19) United States
(12) Patent Application Publication
(10) Pub. No.: US 2020/0042136 A1
(43) Pub. Date: Feb. 6, 2020

(54) KEYPAD DEVICE, INPUT SYSTEM AND OPERATION METHOD

(71) Applicant: E Ink Holdings Inc., Hsinchu (TW)

(72) Inventor: Chun-Wei Chu, Hsinchu (TW)

(73) Assignee: E Ink Holdings Inc., Hsinchu (TW)

(21) Appl. No.: 16/529,795

(22) Filed: Aug. 2, 2019

(30) Foreign Application Priority Data
Aug. 3, 2018 (TW) 107127067

(51) Int. Cl. G06F 3/041; G07C 9/00; G06F 3/0484; G06F 3/0488

(52) U.S. Cl. CPC G06F 3/0416; G07C 9/00817; G06F 3/0412; G07C 2009/00841; G06F 3/04886; G07C 2009/00642; G07C 2009/00214; G06F 3/04842

(57) ABSTRACT

A keypad device, an input system, and an operation method are provided. The keypad device includes a processor, a display, an input unit, and a first communication module. The input unit receives an input data and provides the input data to the processor. When the keypad device is turned on, the first communication module automatically searches for another keypad device and is automatically connected to the another keypad device. The first communication module receives another input data provided by the another keypad device and provides the another input data to the processor. The processor drives the display according to at least one of the input data and another input data so that the display correspondingly displays at least one of input information and another input information.

### CROSS-REFERENCE TO RELATED APPLICATION

This application claims the priority benefit of Taiwan application serial no. 107127067, filed on Aug. 3, 2018. The entirety of the above-mentioned patent application is hereby incorporated by reference herein and made a part of this specification.

### BACKGROUND

### Technical Field

The invention relates to a device featuring a display function and a button unit. More particularly, the invention relates to a keypad device, an input system, and an operation method featuring a display function.

### Description of Related Art

With technology advancement, various terminal electronic products have been developed along with demand from people's daily life. In particular, terminal electronic products featuring the display function or the button function are extensively used in people's daily life. For instance, a terminal electronic product featuring the display function may act as an environment monitoring device disposed at home and is configured to monitor various information of the home environment such as temperature information or humidity information and the like. Alternatively, a terminal electronic product featuring the button function may be an Internet of Things (IoT) endpoint device disposed at home and can be configured to control various types of IoT equipment, such as a refrigerator or an air conditioner and the like. Nevertheless, the terminal electronic products of these types generally feature only the function of displaying specific information or the function of equipment control, and can only be independently operated, as such, more diverse or convenient application effects are unable to be provided. In view of the above, several solutions are provided in the following embodiments.

### SUMMARY

The invention provides a keypad device, an input system, and an operation method capable of providing a display function and a control function through a display and a button unit and capable of sharing data with other adjacent keypad devices to provide effective and diverse application effects.

A keypad device provided by an embodiment of the invention includes a processor, a display, an input unit, and a first communication module. The display is coupled to the processor. The input unit is coupled to the processor. The input unit is configured to receive an input data and provides the input data to the processor. The first communication module is coupled to the processor. When the keypad device is turned on, the first communication module is configured to automatically search for another keypad device and is automatically connected to the another keypad device. The first communication module receives another input data provided by the another keypad device and provides the another input data to the processor. The processor drives the display according to at least one of the input data and another input data so that the display correspondingly displays at least one of input information and another input information.

An input system provided by an embodiment of the invention includes a plurality of keypad devices. Each of the keypad devices includes a processor, a display, an input unit, and a first communication module. The display is coupled to the processor. The input unit is coupled to the processor. The input unit is configured to receive an input data and provides the input data to the processor. The first communication module is coupled to the processor. When a first keypad device of the keypad devices is turned on, the first communication module of the first keypad device is configured to automatically search for a second keypad device of the keypad devices and is automatically connected to the second keypad device. The first communication module of the first keypad device receives another input data provided by the second keypad device and provides the another input data to the processor of the first keypad device. The processor of the first keypad device drives the display according to at least one of the input data and the another input data so that the display of one of the keypad devices correspondingly displays at least one of input information and another input information.

An operation method of a keypad device provided by an embodiment of the invention is suitable for a keypad device. The keypad device includes a processor, a display, an input unit, and a first communication module. The operation method includes the following steps. When the keypad device is turned on, another keypad device is automatically searched through the first communication module, and the another keypad device is automatically connected. Another input data provided by the another keypad device is received through the first communication module, and the another input data is provided to the processor. The display is driven through the processor according to at least one of the input data and another input data so that the display correspondingly displays at least one of input information and another input information.

To sum up, the keypad device, the input system, and the operation method provided by the embodiments of the invention may provide a display and a control function through the display and the button unit. When the keypad device is turned on, the keypad device can automatically search for the another keypad device and can be automatically connected to the another keypad device to form the local network architecture. Therefore, the keypad device provided by the invention can automatically collect the input data provided by other keypad devices in this local network and simultaneously display the input information of the other keypad devices according to the input data provided by the other keypad devices.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of functions of a keypad device according to an embodiment of the invention.

FIG. 2 is a block diagram of functions of a keypad device according to another embodiment of the invention.

FIG. 3 is a schematic view of an example of a keypad device according to an embodiment of the invention.

FIG. 4 is a schematic diagram of an architecture of an input system according to an embodiment of the invention.

FIG. 5A is a schematic diagram of an architecture of a display according to a first embodiment of the invention.

FIG. 5B is a schematic diagram of an architecture of a display according to a second embodiment of the invention.

FIG. 5C is a schematic diagram of an architecture of a display according to a third embodiment of the invention.

FIG. 6 is a flowchart of an operation method according to an embodiment of the invention.

### DESCRIPTION OF THE EMBODIMENTS

In order to make the invention more comprehensible, several embodiments are described below as examples of implementation of the invention. Moreover, elements/components/steps with the same reference numerals are used to represent the same or similar parts in the drawings and embodiments.

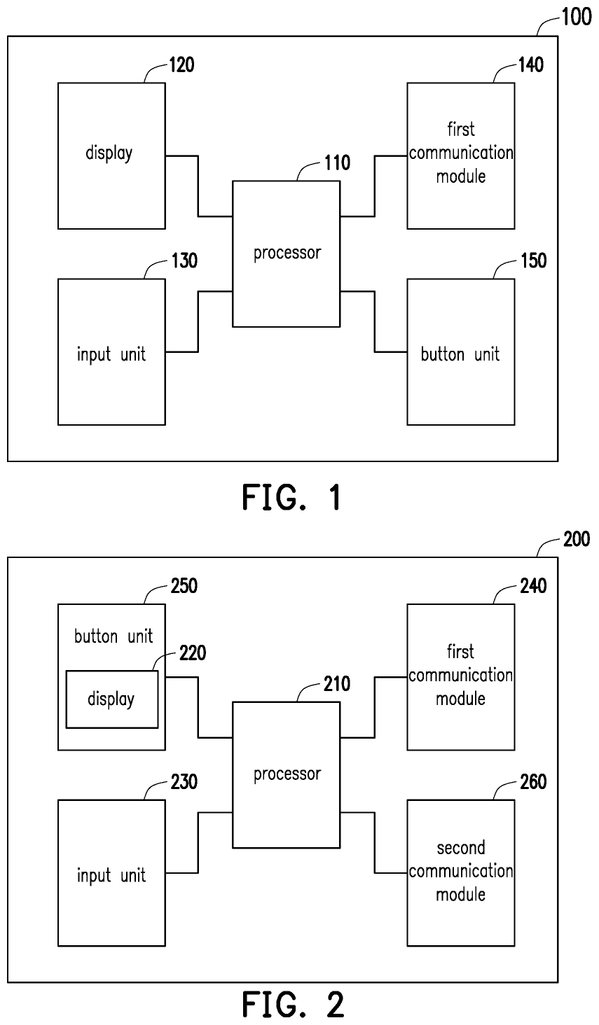

FIG. 1 is a block diagram of functions of a keypad device according to an embodiment of the invention. With reference to FIG. 1, a keypad device 100 includes a processor 110, a display 120, an input unit 130, a first communication module 140, and a button unit 150. The processor 110 is coupled to the display 120, the input unit 130, the first communication module 140, and the button unit 150. In this embodiment, the keypad device 100 can receive an input data through the input unit 130, and the processor 110 can drive the display 120 according to the input data to display corresponding input information. In this embodiment, the input unit 130 may, for example, include a sensing element or a communication connection interface. In this embodiment, the first communication module 140 can automatically search for presence of at least another keypad device within a communication range. If another keypad device is present within the communication range, the first communication module 140 may be automatically connected to the another keypad device to form a local network architecture. Further, the first communication module 140 may receive another input data provided by the another keypad device, and the processor 110 may drive the display 120 according to the another input data to display corresponding another input information. In other words, the keypad device 100 of this embodiment features a display function and can automatically search for another keypad device around, so as to display the another input information of the another keypad device.

Several exemplary embodiments are provided below to describe the keypad device, but the keypad device provided by the invention is not limited to the implementation types in the following examples.

The input unit 130 is exemplified as including a sensing element, and the keypad device 100 may, for example, act as an environment monitoring device. Further, the sensing element may be a temperature sensor, a humidity sensor, a brightness sensor, an image sensor, a positioning sensor, or a power sensor and the like. As such, the input unit 130 may be configured to sense environment information such as ambient temperatures, humidity, brightness, or image screens and the like or location information and power information of a body of the keyboard device 100. The keypad device 100 can automatically sense the environment information, location information, or power information and provides the environment information, location information, or power information to other keypad devices in a local network or receives other environment information, other location information, or other power information in the local network sensed by other keypad devices, so as to obtain distance data between the keypad device 100 and other keypad devices. That is, a user obtains a sensing result of the environment the keypad device 100 is in through the keypad device 100 while other sensing results of the nearby environment other keypad devices are in can be simultaneously displayed as well, or device states of other keypad devices are displayed.

The input unit 130 including a communication connection interface is taken as an example. The keypad device 100 may, for example, act as an endpoint device of Internet of Things (IoT), and the communication connection interface may communicate with corresponding IoT equipment through a wired or wireless manner. In this way, the input unit 130 may receive IoT data of external IoT equipment. For instance, the communication connection interface may be connected to the corresponding IoT equipment through a cable, or the communication connection interface may be connected to the corresponding IoT equipment through Bluetooth or Wi-Fi. The IoT equipment may be a refrigerator, an air conditioner, or other similar equipment such as the abovementioned various sensors. The keypad device 100 may display corresponding IoT information according to the IoT data and provides the IoT information to other keypad devices in the local network or receives other IoT information sensed by other keypad devices in the local network. The IoT information may, for example, include operation information of the refrigerator, operation information of the air conditioner, and other similar equipment information. That is, the user may obtain the IoT information of the IoT equipment connected to the keypad device 100 through the keypad device 100 while other IoT information of other IoT equipment is also simultaneously displayed.

In this embodiment, the first communication module 140 may communicate with at least another keypad device through a wired or wireless manner, and the first communication module 140 may be, for example, a Bluetooth module or a cable module, but the invention is not limited thereto. The first communication module 140 is exemplified as being a Bluetooth module, and when the keypad device 100 is turned on, the first communication module 140 may automatically search for presence of another keypad device within a communication range of the Bluetooth module. If another keypad device is present in the communication range of the Bluetooth module, and if the another keypad device can be connected (is turned on), the first communication module 140 is automatically connected to the another keypad device. Simultaneously, the first communication module 140 automatically receives another input data provided by the another keypad device, so that the keypad device 100 correspondingly displays related input information of the another keypad device according to the another input data. The first communication module 140 is exemplified as being a cable module, and when the first communication module 140 is turned on, the first communication module 140 may automatically search for the connected another keypad device. Further, when the another keypad device can be connected (is turned on), the first communication module 140 is automatically connected to the another keypad device. Simultaneously, the first communication module 140 automatically receives another input data provided by the another keypad device, so that the keypad device 100 correspondingly displays related input information of the another keypad device according to the another input data.

In this embodiment, the button unit 150 may be a physical button and may correspondingly output a control signal to the processor 110 according to an operation result performed by the user. In this way, the processor 110 may execute related functional operation according to the control signal provided by the button unit 150. For instance, the user may select screen content displayed by the display 120 through the button unit 150 or executes a related application software operation through the button unit 150. In this embodiment, the display 120 may be an electro phoretic display, but the invention is not limited thereto. Further, in an embodiment, the display 120 may also be integrated in the button unit 150, so that the button unit 150 can not only provide a button function but also a display function. In another embodiment, the button unit 150 may also be a non-physical button, for example, a virtual button displayed by the display 120 or other devices.

FIG. 2 is a block diagram of functions of a keypad device according to another embodiment of the invention. With reference to FIG. 2, a keypad device 200 includes a processor 210, a display 220, an input unit 230, a first communication module 240, a button unit 250, and a second communication module 260. The processor 210 is coupled to the display 220, the input unit 230, the first communication module 240, the button unit 250, and the second communication module 260. Comparing to the embodiment of FIG. 1, the display 220 of this embodiment may be integrated in the button unit 250. The button unit 250 may be, for example, a mechanical button, and the display 220 is disposed on a pressing surface to provide a display function. Further, in this embodiment, the keypad device 200 further includes the second communication module 260. When the keypad device 200 is turned on, the second communication module 260 can automatically search for an external network router and is automatically connected to the network router. That is, the keypad device 200 of this embodiment may further feature a network connection function.

In this embodiment, when the keypad device 200 is turned on, the keypad device 200 is automatically connected to another keypad device through the first communication module 240 and is automatically connected to the network router through the second communication module 260. In response to that the another keypad device is also connected to the network router, when the keypad device 200 is in a low battery state or a non-effective communication state is provided between the second communication module 260 and the network router, a manner in which the keypad device 200 is connected to the network is switched. In this case, the first communication module 240 is used instead to be connected to the another keypad device, and the keypad device 200 is connected to the network router through the another keypad device. In other words, when the keypad device 200 is unable to effectively communicate with the network router through the second communication module 260, the keypad device 200 may treat the another keypad device as a router so as to execute the network connection function through the another keypad device. Further, in an embodiment, the first communication module 240 may be a Bluetooth module, and the second communication module 260 may be a Wi-Fi module. Hence, the keypad device 200 of this embodiment may further feature an effective network connection capability.

In an embodiment, the keypad device 200, for example, may act as an ordering device, and the keypad device 200 may be on standby for a long time. When the user intends to order a specific product at any time, the user may press the button unit 250, so that the button unit 250 outputs the control signal to the processor 210. Hence, the processor 210 may be connected to the network router through the second communication module 260 and outputs a pre-set ordering signal or ordering data to a network ordering platform or a server through the network router, so as to automatically order the preset specific product. Further, the network ordering platform or the server may correspondingly return related ordering information or product information to the keypad device 200 to be displayed through the display 220. Further, the input unit 230 may be a positioning sensor and is configured to provide positioning data to the processor 210, so that the ordering information outputted by the processor 210 may include positioning location information of the user.

In addition, in this embodiment, people having ordinary skill in the art may acquire sufficient teachings, suggestions, and description of implementation of the processor 210, the display 220, the input unit 230, the first communication module 240, and the button unit 250 with reference to the embodiment of FIG. 1, so that descriptions of other implementation manners and other technical details are not further provided hereinafter.

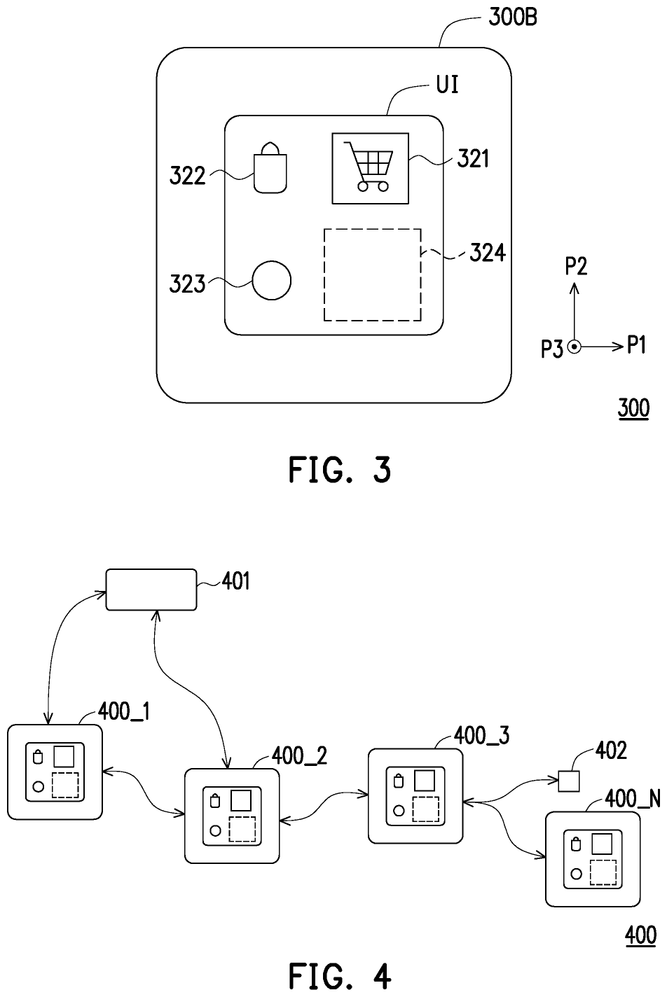

FIG. 3 is a schematic view of an example of a keypad device according to an embodiment of the invention. With reference to FIG. 3, FIG. 3 is a front view of a keypad device 300. The keypad device 300 includes a device body 300B, and various types of functional units as described in FIG. 1 and FIG. 2 may be further disposed in the device body 300B. For instance, a user interface UI may include a plurality of displays 321 and 322, a button unit 323, and a blank region 324. The device body 300B may be disposed on a plane (for example, a wall surface) formed parallel to a first direction P1 and a second direction P2, and the device body 300B displays the user interface UI toward a third direction P3. In this example, the display 321 may provide a display function as well as a button function. The display 321 may display input information of the keypad device 300, and the user may generate a control command through pressing the display 321. For instance, the display 321 may display an ordering icon, and when the user presses the display 321, the display 321 may correspondingly output a command, so that the keypad device 300 correspondingly outputs an ordering confirmation signal to a network server (connected to the network through a router). Alternatively, in an embodiment, the display 321 may display the input data described in the foregoing embodiments, such as the environment information or the IoT equipment information and the like, and the input data is not limited to the icon content shown in FIG. 3.

In this example, the display 322 may provide a display function as well as a touch sensing function. The display 322 can display operation information of the keypad device 300, and the user may perform operation through touching the display 322. For instance, the display 322 can display a lock icon, and when the user touches the display 322, the display 322 may correspondingly output a command, so that the keypad device 300 is correspondingly locked or unlocked. Further, the lock icon of the display 322 may correspondingly present a light turning-on state or a light turning-off state. In this example, the button unit 323 may be a physical button. The button unit 323 may provide a pressing function but does not include a display function. The user may operate on the keypad device 300 directly through pressing the button unit 323. In this embodiment, the display 322 nor the button unit 323 may not have to be disposed in the blank region 324, so that an internal space of the device body 300B is reserved as a hardware allocation space for the foregoing various types of the functional units as described in FIG. 1 and FIG. 2.

Nevertheless, note that the keypad device 300 may be designed to provide a customized user interface UI and is not limited to what is shown in FIG. 3. For instance, in an embodiment, the keypad device 300 may include only the physical button unit 323 for being pressed by the user and correspondingly generates a signal to the network server. Therefore, in an embodiment, the keypad device 300 may feature lower setup costs and lower power consumption. For another instance, in another embodiment, the keypad device 300 may include only the button unit 323 featuring the display function or include only the display 322 featuring the touch sensing function to be conveniently operated by the user.

FIG. 4 is a schematic diagram of an architecture of an input system according to an embodiment of the invention. With reference to FIG. 4, an input system 400 may include a plurality of keypad devices 400_1, 400_2, and 400_3 to 400_N. In this embodiment, each of the keypad devices 400_1, 400_2, and 400_3 to 400N may include the various types of the functional units as described in FIG. 1 and FIG. 2. In this embodiment, the keypad devices 400_1, 400_2, and 400_3 to 400_N may be automatically connected to one another to form a local network architecture. Each of the keypad devices 400_1, 400_2, and 400_3 to 400_N can individually receive an input data and can search for other keypad devices in the local network architecture to receive the input data. In other words, the keypad devices 400_1, 400_2, and 400_3 to 400_N may share data among one another.

Taking the keypad device 400_1 for example, when the keypad device 400_1 is turned on, the keypad device 400_1 automatically searches for presence of other keypad devices within a communication range. When the keypad device 400_2 is found by the keypad device 400_1 and the keypad device 400_2 can also be connected (is turned on), the keypad device 400_1 is automatically connected to the keypad device 400_2. Further, the keypad device 400_1 is automatically connected to a network router 401 to be connected to a network. Nevertheless, when the keypad device 400_1 is in a low battery state or a non-effective communication state is provided between the keypad device 400_1 and the network router 401, the keypad device 400_1 may be connected to the keypad device 400_2 instead. The keypad device 400_2 is also connected to the network router 401, and an effective communication state is provided between the keypad device 400_2 and the network router 401. That is, the keypad device 400_1 may treat the keypad device 400_2 as a router, so as to perform the network connection function through the keypad device 400_2. In other words, if one of the keypad devices 400_1, 400_2, and 400_3 to 400_N is disposed in a location with poor communication quality or is in the low battery state, the one of the keypad devices 400_1, 400_2, and 400_3 to 400N may still perform the network connection function through other keypad devices.

Taking the keypad device 400_2 for example, when the keypad device 400_2 is turned on, the keypad device 400_2 automatically searches for presence of other keypad devices within the communication range. When the keypad device 400_1 and the keypad device 400_3 are found by the keypad device 400_2 and the keypad device 400_1 and the keypad device 400_3 can also be connected (are turned on), the keypad device 400_2 is automatically connected to the keypad device 400_1 and the keypad device 400_3. The keypad device 400_2 may receive the input data such as the data of the abovementioned environment information or the IoT equipment information through an input unit, so as to display corresponding input information through the display. Further, the keypad device 400_2 may automatically receive the input data individually provided by the keypad device 400_1 and the keypad device 400_3 through a communication module and automatically provides its own input data (i.e., the input data of the keypad device 400_2) through the communication module to the keypad device 400_1 and the keypad device 400_3. Hence, the keypad device 400_2 may further display the related input information of the adjacent keypad device 400_1 and the keypad device 400_3 through the display. In another example, if the keypad device 400_2 is disposed in a kitchen and the keypad device 400_3 is disposed in a bathroom, the user may use the keypad device 400_2 in the kitchen to obtain environment information or IoT equipment information of the bathroom. Hence, the input system 400 may provide a convenient and effective environment monitoring function or IoT function.

Taking the keypad device 400_3 for example, when the keypad device 400_3 is turned on, the keypad device 400_3 automatically searches for presence of other keypad devices within the communication range. When the keypad device 400_2, the keypad device 400_N, and a sensor 402 are found by the keypad device 400_3 and the keypad device 400_2 and the keypad device 400_N can also be connected (are turned on), the keypad device 400_3 is automatically connected to the keypad device 400_2, the keypad device 400_N, and the sensor 402. The keypad device 400_3 not only shares data with the keypad device 400_2 and the keypad device 400_N but also obtains sensing data from the sensor 402. For another example, if the keypad device 400_3 is disposed in a bathroom and the sensor 402 is a humidity sensor, when being in the bathroom, the user may obtain humidity information of the bathroom through the keypad device 400_3. The keypad device 400_3 may be connected to other sensors and is not limited to the illustration shown in FIG. 4.

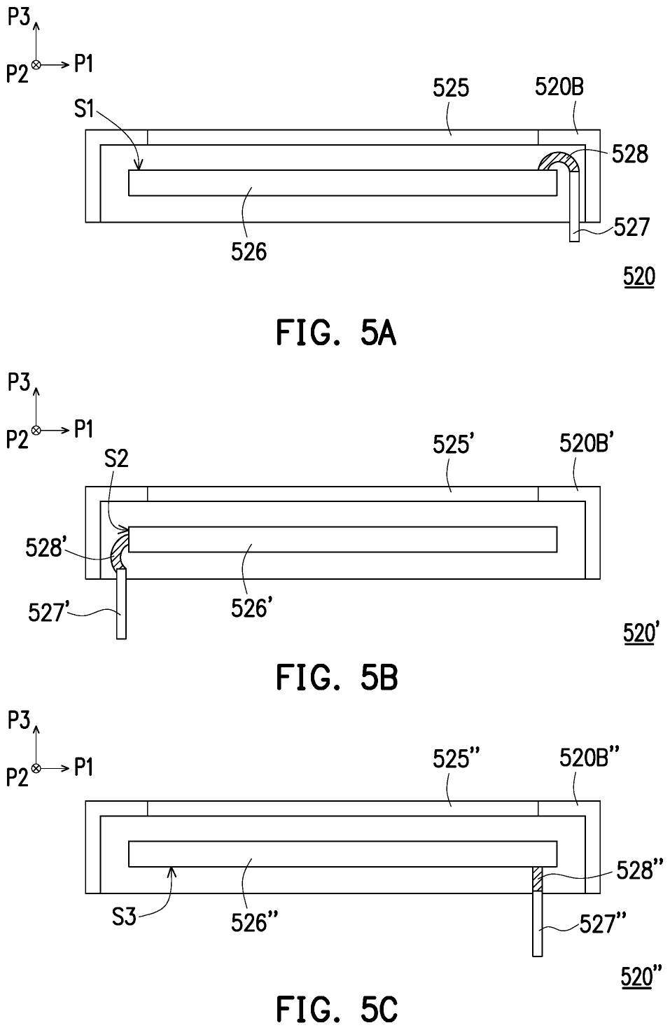

FIG. 5A is a schematic diagram of an architecture of a display according to a first embodiment of the invention. With reference to FIG. 5A, an architecture of a display 520 of this embodiment may be applicable to the display provided in each of the embodiments of the invention. The display housing 520B of the display 520 extends in the first direction P1 and the second direction P2, and the display surface of the display 520 faces the third direction P3. In this embodiment, the display 520 may include a display housing 520B, a display panel 526, and a circuit board 527. The display housing 520B includes a transparent panel 525. The display panel 526 is disposed below the transparent panel 525. The display panel 526 is electrically connected to the circuit board 527 through a trace 528. The circuit board 527 includes a display driving circuit. The display driving circuit is configured to drive the display panel and is further electrically connected to a processor. In this embodiment, the display panel 526 may be an electro phoretic display panel, but the invention is not limited thereto. In this embodiment, the trace 528 may be connected to the circuit board 527 through an upper surface S1 of the display panel 526, so that the circuit board 527 can be disposed at a side of or below the display panel 526. Accordingly, comparing to a general display driving circuit which is disposed in a panel region at a periphery of the display panel 526, the display driving circuit of this embodiment may be disposed on the circuit board 527. Further, wires are drawn from the circuit board 527 to each of display elements of the display panel 526 to drive the display panel 526. In other words, the display driving circuit is not required to be disposed in the panel region at the periphery of the display panel 526 of the embodiment, so that a relatively large display region is provided, and an opening region (i.e., a size of the transparent panel 525) of the display housing 520B may also be effectively expanded. Therefore, the display 520 of this embodiment features a narrow border.

FIG. 5B is a schematic diagram of an architecture of a display according to a second embodiment of the invention. With reference to FIG. 5B, an architecture of a display 520′ of this embodiment may be applicable to the display provided in each of the embodiments of the invention. FIG. 5B is a side view of the display 520′. The display housing 520B′ of the display 520′ extends in the first direction P1 and the second direction P2, and the display surface of the display 520′ faces the third direction P3. In this embodiment, the display 520′ may include a display housing 520B′, a display panel 526′, and a circuit board 527′. The display housing 520B′ includes a transparent panel 525′. The display panel 526′ is disposed below the transparent panel 525′. The display panel 526′ is electrically connected to the circuit board 527′ through a trace 528′. The circuit board 527′ includes a display driving circuit. The display driving circuit is configured to drive the display panel and is further electrically connected to a processor. In this embodiment, the display panel 526′ may be an electro phoretic display panel, but the invention is not limited thereto. Comparing to FIG. 5A, the trace 528′ of this embodiment may be connected to the circuit board 527′ through a side surface S2 of the display panel 526′, so that the circuit board 527′ can be disposed at a side of or below the display panel 526′. Accordingly, comparing to a general display driving circuit which is disposed in a panel region at a periphery of the display panel 526′, the display driving circuit of this embodiment may be disposed on the circuit board 527′. Further, wires are drawn from the circuit board 527′ to each of display elements of the display panel 526′ to drive the display panel 526′. In other words, the display driving circuit is not required to be disposed in the panel region at the periphery of the display panel 526′ of the embodiment, so that a relatively large display region is provided, and an opening region (i.e., a size of the transparent panel 525′) of the display housing 520B′ may also be effectively expanded. Therefore, the display 520′ of this embodiment features a narrow border.

FIG. 5C is a schematic diagram of an architecture of a display according to a third embodiment of the invention. With reference to FIG. 5C, an architecture of a display 520″ of this embodiment may be applicable to the display provided in each of the embodiments of the invention. FIG. 5C is a side view of the display 520″. The display housing 520B″ of the display 520″ extends in the first direction P1 and the second direction P2, and the display surface of the display 520″ faces the third direction P3. In this embodiment, the display 520″ may include a display housing 520B″, a display panel 526″, and a circuit board 527″. The display housing 520B″ includes a transparent panel 525″. The display panel 526″ is disposed below the transparent panel 525″. The display panel 526″ is electrically connected to the circuit board 527″ through a trace 528″. The circuit board 527″ includes a display driving circuit. The display driving circuit is configured to drive the display panel and is further electrically connected to a processor. In this embodiment, the display panel 526″ may be an electro phoretic display panel, but the invention is not limited thereto. Comparing to FIG. 5A, the trace 528″ of this embodiment may be connected to the circuit board 527″ through a lower surface S3 of the display panel 526″, so that the circuit board 527″ can be disposed below the display panel 526″. Accordingly, comparing to a general display driving circuit which is disposed in a panel region at a periphery of the display panel 526″, the display driving circuit of this embodiment may be disposed on the circuit board 527″. Further, wires are drawn from the circuit board 527″ to each of display elements of the display panel 526″ to drive the display panel 526″. In other words, the display driving circuit is not required to be disposed in the panel region at the periphery of the display panel 526″ of the embodiment so that a relatively large display region is provided, and an opening region (i.e., a size of the transparent panel 525″) of the display housing 520B″ may also be effectively expanded. Therefore, the display 520″ of this embodiment features a narrow border.

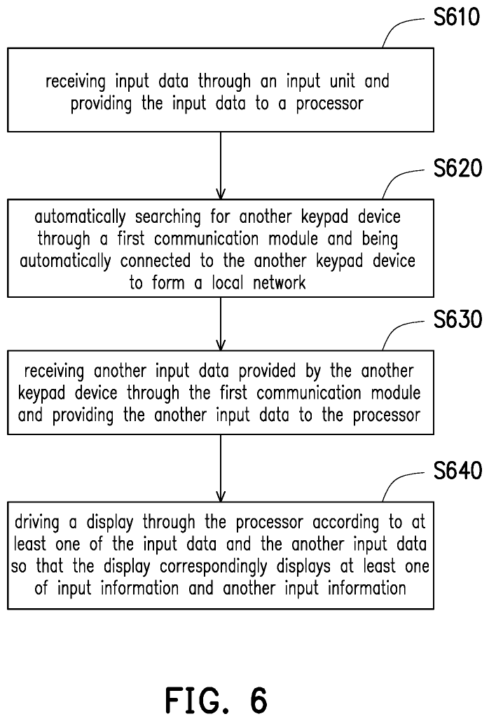

FIG. 6 is a flowchart of an operation method according to an embodiment of the invention. The operation method of this embodiment may at least be applicable to the keypad devices described in each of the embodiments of the invention. Taking the keypad device 100 of FIG. 1 for example, with reference to FIG. 1 and FIG. 6, the keypad device 100 includes the processor 110, the display 120, the input unit 130, and the first communication module 140. When the keypad device 100 is turned on, the keypad device 100 may automatically perform the following steps S610 to S640. In step S610, the keypad device 100 receives an input data through the input unit 130 and provides the input data to the processor 110. In step S620, the keypad device 100 may automatically search for another keypad device through the first communication module 140 and is automatically connected to the another keypad device. In step S630, the keypad device 100 may receive another input data provided by the another keypad device through the first communication module 140 and provides the another input data to the processor 110. In step S640, the keypad device 100 may drive the display 120 through the processor 110 according to at least one of the input data and the another input data, so that the display 120 correspondingly displays at least one of input information and another input information. That is, in the operation method provided by the present embodiment, the keypad device 100 may automatically form a local network architecture together with adjacent keypad devices that can be connected, and the keypad device 100 may simultaneously display the input information received by itself as well as the another input information of the adjacent keypad devices that can be connected. Therefore, the operation method of this embodiment may provide diverse and rich information display functions through the keypad device 100.

In addition, in this embodiment, people having ordinary skill in the art may acquire sufficient teachings, suggestions, and description of implementation of the keypad device 100 with reference to the embodiments of FIG. 1 to FIG. 5C, and that other implementation manners, functional unit features, or technical details are not further provided hereinafter.

In view of the foregoing, the keypad device, the input system, and the operation method provided by the invention are capable of being automatically connected to the other adjacent keypad devices to form the local network architecture and are capable of sharing data with the other adjacent keypad devices. In addition, the keypad device, the input system, and the operation method provided by the invention further feature a network connection function. Further, when connection quality is poor or when battery is low, automatic switching is performed, so that the network connection function is performed through the other adjacent keypad devices. Therefore, the keypad device, the input system, and the operation method provide diverse information content and can be effectively connected to the network to provide the diverse and convenient application effects.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A keypad device, comprising:
a processor;
a display, coupled to the processor;
an input unit, coupled to the processor, configured to receive an input data, providing the input data to the processor; and
a first communication module, coupled to the processor, the first communication module being configured to automatically search for another keypad device when the keypad device is turned on and being automatically connected to the another keypad device, wherein the first communication module receives another input data provided by the another keypad device and provides the another input data to the processor,
wherein the processor drives the display according to at least one of the input data and the another input data so that the display correspondingly displays at least one of input information and another input information.

2. The keypad device as claimed in claim 1, wherein the first communication module provides the input data to the another keypad device when the first communication module is automatically connected to the another keypad device.

3. The keypad device as claimed in claim 1, further comprising:
a second communication module, coupled to the processor, the second communication module being configured to automatically search for a network router when the keypad device is turned on and being automatically connected to the network router,
wherein the first communication module and the second communication module are applicable to different communication protocol standards.

4. The keypad device as claimed in claim 3, wherein when the first communication module is automatically connected to the another keypad device, the first communication module is connected to the network router further through the another keypad device if the keypad device is in a low battery state or if a non-effective communication state is provided between the second communication module and the network router.

5. The keypad device as claimed in claim 1, wherein the display comprises:
a display housing, comprising a transparent panel;
a display panel, disposed below the transparent panel; and
a circuit board, comprising a display driving circuit, electrically connected to the display panel through a trace so as to be configured to drive the display panel,
wherein the trace is connected to the circuit board through an upper surface, a side surface, or a lower surface of the display panel, and the circuit board is disposed at a side of or below the display panel.

6. The keypad device as claimed in claim 1, further comprising:
a button unit, coupled to the processor, the button unit configured to output a control signal to the processor when the button unit is operated.

7. The keypad device as claimed in claim 6, wherein the display is integrated in the button unit.

8. The keypad device as claimed in claim 1, wherein a local network architecture is formed between the keypad device and the another keypad device when the keypad device is automatically connected to the another keypad device, and the keypad device and the another keypad device share data with each other.

9. An input system, comprising:
a plurality of keypad devices, wherein each of the keypad devices comprises:
a processor;
a display; coupled to the processor;
an input unit, coupled to the processor, configured to receive an input data, providing the input data to the processor; and
a first communication module, coupled to the processor,
wherein when a first keypad device of the keypad devices is turned on, the first communication module of the first keypad device is configured to automatically search for a second keypad device of the keypad devices and is automatically connected to the second keypad device, wherein the first communication module of the first keypad device receives another input data provided by the second keypad device and provides the another input data to the processor of the first keypad device,
wherein the processor of the first keypad device drives the display according to at least one of the input data and the another input data so that the display of the first keypad device correspondingly displays at least one of input information and another input information.

10. The input system as claimed in claim 9, wherein the first communication module of the first keypad device provides the input data to the second keypad device when the first communication module of the first keypad device is automatically connected to the second keypad device.

11. The input system as claimed in claim 9, wherein each of the keypad devices further comprises:
a second communication module, coupled to the processor,
wherein the second communication module of one of the keypad devices is configured to automatically search for a network router when one of the keypad devices is turned on and is automatically connected to the network router,
wherein the first communication module and the second communication module are applicable to different communication protocol standards.

12. The input system as claimed in claim 11, wherein when the first communication module of the first keypad device is automatically connected to the second keypad device, the first communication module of the first keypad device is connected to the network router further through the second keypad device if the first keypad device is in a low battery state or if a non-effective communication state is provided between the second communication module of the first keypad device and the network router.

13. The input system as claimed in claim 9, wherein the display comprises:
a display housing, comprising a transparent panel;
a display panel, disposed below the transparent panel; and
a circuit board, comprising a display driving circuit, electrically connected to the display panel through a trace so as to be configured to drive the display panel,
wherein the trace is connected to the circuit board through an upper surface, a side surface, or a lower surface of the display panel, and the circuit board is disposed at a side of or below the display panel.

14. The input system as claimed in claim 9, wherein each of the keypad devices further comprises:
a button unit, coupled to the processor, the button unit configured to output a control signal to the processor when the button unit is operated.

15. The input system as claimed in claim 14, wherein the display is integrated in the button unit.

16. The input system as claimed in claim 9, wherein a local network architecture is formed between one of the keypad devices and another one of the keypad devices when one of the keypad devices is automatically connected to another one of the keypad devices, and one of the keypad devices and another one of the keypad devices share data with each other.

17. An operation method of a keypad device, suitable for a keypad device, wherein the keypad device comprises a processor, a display, an input unit, and a first communication module, and the operation method comprises:
receiving input data through the input unit when the keypad device is turned on and providing the input data to the processor;
automatically searching for another keypad device through the first communication module when the keypad device is turned on and being automatically connected to the another keypad device;
receiving another input data provided by the another keypad device through the first communication module and providing the another input data to the processor; and
driving the display through the processor according to at least one of the input data and the another input data so that the display correspondingly displays at least one of input information and another input information.

18. The operation method as claimed in claim 17, further comprising:
providing the input data to the another keypad device through the first communication module when the first communication module is automatically connected to the another keypad device.

19. The operation method as claimed in claim 17, wherein the keypad device further comprises a second communication module, and the operation method further comprises:
automatically searching for a network router through the second communication module when the keypad device is turned on and being automatically connected to the network router,
wherein the first communication module and the second communication module are applicable to different communication protocol standards.

20. The operation method as claimed in claim 19, further comprising:
when the first communication module is automatically connected to the another keypad device, the first communication module being connected to the network router further through the another keypad device if the keypad device is in a low battery state or if a non-effective communication state is provided between the second communication module and the network router.
